(19) United States
(12) Patent Application Publication
(10) Pub. No.: US 2008/0019703 A1
(43) Pub. Date: Jan. 24, 2008

(54) Optical Transmitter Using Nyquist Pulse Shaping

(75) Inventor: Jerry D. Burchfiel, Waltham, MA (US)

Correspondence Address: RAUSCHENBACH PATENT LAW GROUP, LLC, P.O. BOX 387, BEDFORD, MA, 01730, US

(73) Assignee: BBN TECHNOLOGIES CORP., Cambridge, MA (US)

(21) Appl. No.: 11/459,256

(22) Filed: Jul. 21, 2006

(51) Int. Cl. H04B 10/04; H04B 10/12

(52) U.S. Cl. 398/183

(57) ABSTRACT

An optical data transmitter includes a symbol generator that generates a stream of symbols having a symbol rate. A Nyquist filter that is electrically connected to the symbol generator generates a Nyquist filtered stream of symbols. An optical modulator modulates an optical beam with the Nyquist filtered stream of symbols to generate a modulated optical beam. The symbol rate is greater than a bandwidth of the modulated optical beam.

### BACKGROUND OF THE INVENTION

The section headings used herein are for organizational purposes only and should not to be construed as limiting the subject matter described in the present application.

The present invention relates to methods and apparatus for achieving optical signaling near baseband limits. The term “optical signal” as used herein is equivalent to optical modulation. The original low frequency components of a signal before modulation are often referred to as the baseband signal. A signal's “baseband bandwidth” is defined herein as its bandwidth before modulation and multiplexing or after demuliplexing and demodulation.

### BRIEF DESCRIPTION OF THE DRAWINGS

The aspects of this invention may be better understood by referring to the following description in conjunction with the accompanying drawings. Identical or similar elements in these figures may be designated by the same reference numerals. Detailed description about these similar elements may not be repeated. The drawings are not necessarily to scale. The skilled artisan will understand that the drawings, described below, are for illustration purposes only. The drawings are not intended to limit the scope of the present teachings in any way.

FIG. 1 is a block diagram of an optical data transmitter that performs pulse shaping according to the present invention.

FIG. 2 is a block diagram of an N-bit quadrature amplitude modulation optical data transmitter that performs pulse shaping according to the present invention.

### DETAILED DESCRIPTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art. For example, some aspects of the optical data transmitter of the present invention are described in connection with QAM optical data transmitters. It is understood that the optical data transmitter of the present invention can transmit optical data with numerous data formats and is not limited to QAM optical data transmissions.

It should be understood that the individual steps of the methods of the present invention may be performed in any order and/or simultaneously as long as the invention remains operable. Furthermore, it should be understood that the apparatus and methods of the present invention can include any number or all of the described embodiments as long as the invention remains operable.

Known optical signaling techniques of modulating baseband data include non-return-to-zero (NRZ) and return-to-zero (RZ) optical modulation. Return-to-zero modulation pulses drop or return to zero between each modulation pulse. The modulation pulses return to zero even if the data signal includes numerous consecutive zeros or ones. Therefore, return-to-zero modulation pulses are self-clocking and, consequently, signaling using a return-to-zero modulation format does not require a separate clock signal.

Non-return-to-zero optical modulation pulses use a binary code data format in which “1s” are represented by one significant condition and “0s” are represented by another significant condition. The data level only changes when the information transitions from a one to a zero or visa versa. Non-return-to-zero modulation pulses do not have a neutral condition, such as the zero amplitude used in pulse amplitude modulation formats, the zero phase shift used in phase-shift keying (PSK) formats and the mid-frequency used in frequency-shift keying (FSK) formats. Non-return-to-zero pulses generally have more energy than RZ pulses.

Optical transmitters according to the present invention use pulse shaping to reduce intersymbol interference. The term “intersymbol interference” (ISI) is defined herein as distortions that are manifested in temporal spreading and the resulting overlap of individual pulses to such a high degree that a receiver cannot reliably distinguish between individual symbols. Intersymbol interference compromises the integrity of the received data. Thus, the pulse shaping of the present invention increases the operational bandwidth of the optical modulator, provides efficient bandwidth utilization, and reduces timing errors.

In particular, an optical data transmitter of the present invention generates Nyquist pulse filtered symbols for signaling in order to achieve signaling bandwidths that are nearly twice the baseband amplifier bandwidth. In theory, an optical data transmitter according to the present invention will not have any inter-symbol interference and will achieve the maximum theoretically possible signaling rate.

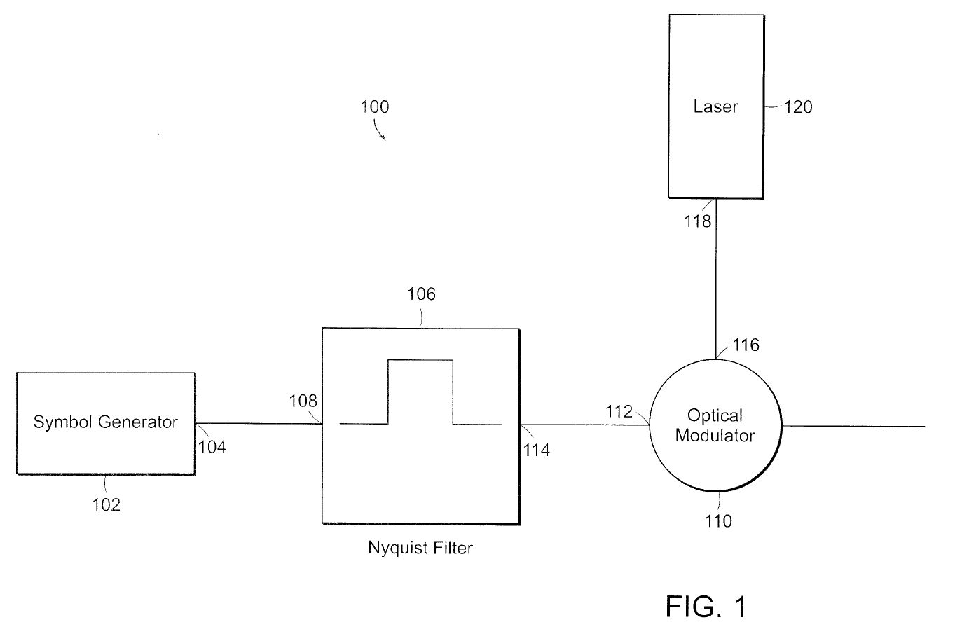

FIG. 1 is a block diagram of an optical data transmitter 100 that performs pulse shaping according to the present invention. The optical data transmitter 100 includes a symbol generator 102 that generates a stream of symbols at an output 104. In various embodiments, the symbol generator 102 can generate numerous types of symbols data formats that are known in the art.

In one embodiment, the stream of symbols generated by the symbol generator 102 is an impulse stream. In another embodiment, the stream of symbols generated by the symbol generator 102 is a RZ pulse stream. In another embodiment, the stream of symbols generated by the symbol generator 102 is a NRZ pulse stream. In another embodiment, the stream of symbols generated by the symbol generator 102 is a quadrature amplitude modulated pulse stream. In yet another embodiment, the stream of symbols generated by the symbol generator 102 is a polarization multiplexed pulse stream.

In some embodiments, the symbol generator 102 comprises a digital memory device that stores look-up table data and a digital-to-analog converter that converts selected look-up table data in the memory device to the desired stream of symbols. The look-up table data can comprise data that is selected to generate a stream of symbols that at least partially compensates for non-linear effects introduced during modulation.

The optical data transmitter 100 also includes a Nyquist filter 106 having an input 108 that is electrically connected to the output 104 of the symbol generator 102. The Nyquist filter 106 filters the stream of symbols. The response of the Nyquist filter 106 in the frequency domain can be represented as the convolution of a rectangular function with a real even symmetric frequency function. The shape of the Nyquist pulses generated by the Nyquist filter 106 in the time domain can be mathematically represented by a sinc(t/T) function.

A brick-wall Nyquist filter is a theoretically ideal Nyquist filter. Such a filter would produce a Nyquist filtered stream of symbols that is completely free of intersymbol interference when the symbol rate is less than or equal to the Nyquist frequency. In practice, however, a brick-wall Nyquist filter can not be achieved because the response of an ideal Nyquist filter continues for all time.

The filter characteristics of a brick-wall Nyquist filter can be approximated with a raised cosine filter. Raised cosine filters are well known in the art. The time response of a raised cosine filter falls off much faster than the time response of a Nyquist pulse. Such filters produce a filtered stream of symbols that is free of intersymbol interference when the symbol rate is less than or equal to the Nyquist frequency. Some intersymbol interference can be introduced when the stream of symbols is detected across a channel.

The filter characteristics of a brick-wall Nyquist filter can also be approximated with a root raised cosine filter. Root raised cosine filters are also well known in the art. In a root raised cosine filter, half of a raised cosine filter is implemented in the transmitter and the other half is implemented in the receiver portion of a communication system. The transmitter and the receive filters are matched and there is no intersymbol interference introduced during detection. Nyquist filters, such as the raised cosine filter and the root raised cosine filter, can be constructed from coaxial transmission lines, microstrip transmission lines, or tapped delay lines.

The optical data transmitter 100 also includes an optical modulator 110 having an electrical input 112 that is coupled to the output 114 of the Nyquist filter 106. The optical modulator 110 also includes an optical input 116 that is coupled to the output 118 of an optical source, such as a laser 120. In many embodiments, the optical modulator 110 is designed and operated to be linear over the desired operating range.

In the embodiment shown, the optical modulator 110 is an external optical modulator where the optical input 116 is coupled to the output 118 of the laser 120. For example, in these embodiments, the external optical modulator can be a Mach-Zehnder interferometric modulator. In various embodiments, the laser generates either a CW optical beam or a pulsed optical beam. In other embodiments, the optical modulator 110 is a directly modulated optical source, such as a directly modulated laser.

The optical modulator 110 modulates an optical beam with the Nyquist filtered stream of symbols to generate a modulated optical beam. Using the optical transmitter of the present invention, the symbol rate of the stream of symbols generated by the symbol generator 102 can be greater than a bandwidth of the modulated optical beam. In some embodiments, the symbol rate approaches twice the bandwidth of the modulated optical beam.

A method of optically modulating a stream of symbols according to the present invention includes generating a stream of symbols having a symbol rate. For example, the generating the stream of symbols can comprise generating at least one of an impulse, a NRZ pulse, and a RZ pulse. The generating the stream of symbols can also comprise generating a stream of quadrature amplitude modulated pulses. In addition, the generating the stream of symbols can comprise generating a stream of polarization multiplexed pulses. In some embodiments, at least some of the stream of symbols is modified to at least partially compensate for non-linear effects introduced when modulating the optical beam or when generating the stream of symbols.

The stream of symbols is then filtered with a Nyquist filter 106. An optical beam is then modulated with the filtered stream of symbols. The optical beam can be externally or directly modulated. The symbol rate is greater than a modulation bandwidth of the modulated optical beam. In some embodiments, the symbol rate approaches twice the modulation bandwidth.

The method of optically modulating a stream of symbols according to the present invention can reduce or essentially eliminate intersymbol interference at high symbol rates which results in more efficient bandwidth utilization. Thus, a method of optically modulating a stream of symbols according to the present invention results in a data transmission that is more robust to timing errors.

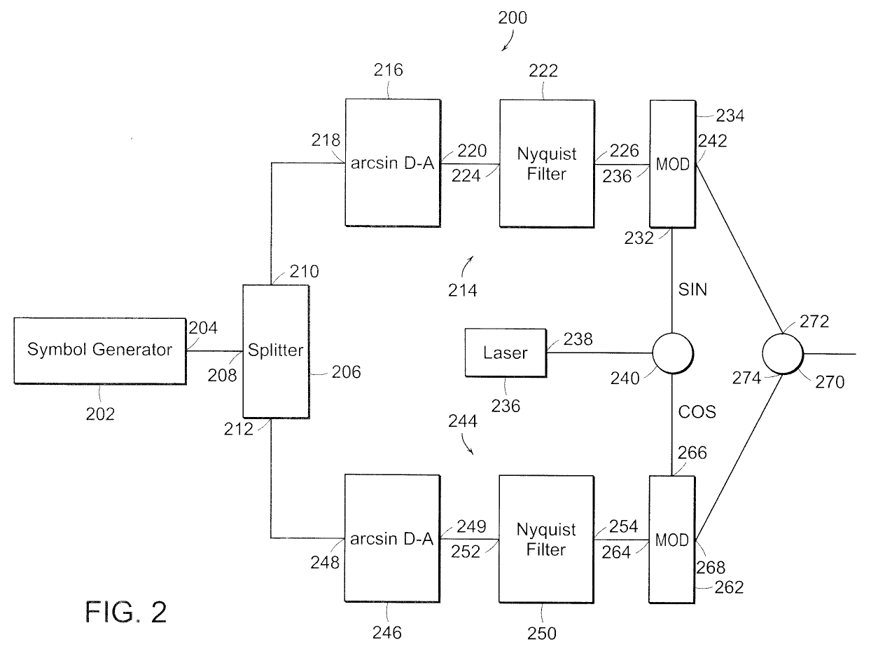

FIG. 2 is a block diagram of an N-bit quadrature amplitude modulation optical data transmitter 200 that performs pulse shaping according to the present invention. Quadrature amplitude modulation (QAM) is a modulation scheme that conveys data by changing or modulating the amplitude of two carrier waves. The two carrier waves, which are typically sinusoidal waves, are out-of-phase with respect to each other by 90 degrees. These two carrier waves are sometimes called quadrature carrier waves in the literature. The two modulated signals are sometimes referred to as the I-signal and the Q-signal. Quadrature amplitude modulation can be used to modulate analog or digital signals, however, QAM is most commonly used to modulate digital signals.

The constellation points for quadrature amplitude modulation in a constellation diagram are typically arranged in a square grid with equal vertical and horizontal spacing. The number of points on the grid is a power of two for binary digital data. The most common forms of quadrature amplitude modulation are 16-QAM, 64-QAM, 128-QAM, and 256-QAM. Using a higher order constellation allows the transmission of more bits per symbol.

The QAM optical data transmitter 200 includes a symbol generator 202 that generates a plurality of N-bit streams of symbols at an output 204. In some embodiments, the symbol generator 202 comprises a memory containing look-up table data and a digital-to-analog converter. In these embodiments, the digital-to-analog converter converts the look-up table data to the plurality of N-bit streams of symbols. In these embodiments, the look-up table data can include data selected to generate a plurality of N-bit streams of symbols that at least partially compensates for non-linear effects introduced during modulation.

The QAM optical data transmitter 200 also includes a splitter 206. The splitter 206 includes input 208 that is coupled to the output 204 of the symbol generator 202. The splitter 206 directs a first N/2-bit stream of symbols to a first output 210 and to a second N/2-bit stream of symbols to a second output 212. In other embodiments, the QAM optical data transmitter 200 does not include the splitter 206, but instead includes a memory look-up table that retrieves the first and the second N/2-bit stream of symbols. The data in the look-up table may be selected to compensate for non-linearities, such as non-linearities introduced during modulation.

The QAM optical data transmitter 200 includes an I-channel 214 that includes a first digital-to-analog converter 216 having an input 218 that is electrically connected to the first output 210 of the splitter 206. The first digital-to-analog converter 216 generates an analog signal representing the first N/2-bit stream of symbols at an output 220. A first Nyquist filter 222 includes an input 224 that is coupled to the output 220 of the first digital-to-analog converter 216. The first Nyquist filter 222 generates an I-channel Nyquist filtered N/2-bit stream of symbols at an output 226.

A first optical modulator 234 is used to modulate the I-channel Nyquist filtered N/2-bit stream of symbols. In one embodiment, the first optical modulator 234 is an external optical modulator, such as a Mach-Zehnder interferometric modulator. The first optical modulator 234 includes an electrical input 236 that is coupled to the output 226 of the first Nyquist filter 222 and an optical input 232 that is coupled to an optical source, such as a laser 236.

The laser 236 generates an optical signal at an output 238. In various embodiments, the laser 236 generates either a CW optical beam or a pulsed optical beam. A splitter 240 splits the optical signal and directs a sine wave portion of the optical signal to the optical input 232 of the first optical modulator 234. An output 242 of the first optical modulator 234 generates a first modulated optical signal.

In addition, the QAM optical data transmitter 200 includes a Q-channel 244 comprising a second digital-to-analog converter 246 having an input 248 that is electrically connected to the second output 212 of the splitter 206. The second digital-to-analog converter 246 generates an analog signal representing the second N/2-bit stream of symbols at an output 249. A second Nyquist filter 250 includes an input 252 that is coupled to the output 249 of the second digital-to-analog converter 246. The second Nyquist filter 250 generates a Q-channel Nyquist filtered N/2-bit stream of symbols at an output 254.

A second optical modulator 262 modulates the combined signal. In one embodiment, the second optical modulator 262 is an external optical modulator, such as a Mach-Zehnder interferometric modulator. In other embodiments, the second optical modulator 262 is a directly modulated optical source, such as a directly modulated laser. The second optical modulator 262 includes an electrical input 264 that is coupled to the output 254 of the second Nyquist filter 250. In addition, the second optical modulator 262 includes an optical input 266 that is coupled to the laser 236.

The laser 236 generates an optical signal at the output 238. The splitter 240 splits the optical signal and directs a cosine wave portion of the optical signal to the optical input 266 of the second optical modulator 262. An output 268 of the second optical modulator 262 generates a second modulated optical signal.

The QAM optical data transmitter 200 also includes a combiner 270 having a first electrical input 272 that is coupled to the I-channel 214 at the output 242 of the first optical modulator 234 and a second electrical input 274 that is coupled to the Q-channel 244 at the output 268 of the second optical modulator 262. The combiner 270 combines the first and the second modulated optical signals and generates an optical beam that is modulated with both the first and the second N/2-bit Nyquist filtered stream of symbols.

The symbol rate of the modulated optical beam is greater than N times the bandwidth of the first and the second modulated optical beams. In some embodiments, the symbol rate approaches twice the bandwidth of the modulated optical beam. For example, if a 40 GHz clock signal is modulated with 16-QAM, a 160 Gb/sec modulated signal can be achieved.

### EQUIVALENTS

While the present teachings are described in conjunction with various embodiments and examples, it is not intended that the present teachings be limited to such embodiments. On the contrary, the present teachings encompass various alternatives, modifications and equivalents, as will be appreciated by those of skill in the art, may be made therein without departing from the spirit and scope of the invention as defined by the appended claims.

What is claimed is:

1. An optical data transmitter comprising:
a) a symbol generator that generates a stream of symbols having a symbol rate at an output;
b) a Nyquist filter having an input that is electrically connected to the output of the symbol generator, the Nyquist filter generating a Nyquist filtered stream of symbols; and
c) an optical modulator having an electrical input that is coupled to the output of the Nyquist filter, the optical modulator modulating an optical beam with the Nyquist filtered stream of symbols to generate a modulated optical beam, wherein the symbol rate is greater than a bandwidth of the modulated optical beam.

2. The optical data transmitter of claim 1 wherein the stream of symbols generated by the symbol generator comprises impulses.

3. The optical data transmitter of claim 1 wherein the stream of symbols generated by the symbol generator comprises NRZ pulses.

4. The optical data transmitter of claim 1 wherein the stream of symbols generated by the symbol generator comprises RZ pulses.

5. The optical data transmitter of claim 1 wherein the stream of symbols generated by the symbol generator comprises quadrature amplitude modulated pulses.

6. The optical data transmitter of claim 1 wherein the stream of symbols generated by the symbol generator comprises polarization multiplexed pulses.

7. The optical data transmitter of claim 1 wherein the symbol generator comprises a memory containing look-up table data and a digital-to-analog converter, the digital-to-analog converter converting the look-up table data to the stream of symbols.

8. The optical data transmitter of claim 7 wherein the look-up table data comprises data selected to generate a stream of symbols that at least partially compensates for non-linear effects introduced during modulation.

9. The optical data transmitter of claim 1 wherein the Nyquist filter comprises a raised cosine filter that approximates a brick wall Nyquist filter.

10. The optical data transmitter of claim 1 wherein the Nyquist filter comprises a passive filter comprising at least one of a coaxial transmission line, a microstrip transmission line, and a tapped delay line.

11. The optical data transmitter of claim 1 wherein the optical modulator comprises a directly modulated laser.

12. The optical data transmitter of claim 1 wherein the optical modulator comprises an external optical modulator having an optical input that is coupled to an output of an optical source.

13. The optical data transmitter of claim 12 wherein the external modulator comprises a Mach-Zehnder interferometric modulator.

14. The optical data transmitter of claim 12 wherein the optical source generates a CW optical beam.

15. The optical data transmitter of claim 12 wherein the optical source generates a pulsed optical beam.

16. The optical data transmitter of claim 1 wherein the symbol rate approaches twice the bandwidth of the modulated optical beam.

17. An N-bit quadrature amplitude modulation optical data transmitter comprising:
a) a symbol generator that generates a plurality of N-bit streams of symbols having a symbol rate at an output;
b) a splitter having an input that is coupled to the output of the symbol generator, the splitter directing a first N/2-bit stream of symbols to a first output and a second N/2-bit stream of symbols to a second output;
c) an I-channel comprising:
i. a first digital-to-analog converter having an input that is electrically connected to the first output of the splitter, the first digital-to-analog converter generating an analog signal representing the first N/2-bit stream of symbols at an output;
ii. a first Nyquist filter having an input that is coupled to the output of the first digital-to-analog converter, the first Nyquist filter generating an I-channel Nyquist filtered N/2-bit stream of symbols; and
iii. a multiplier that multiplies the first Nyquist filtered N/2-bit stream of symbols by a cosine function optical waveform to generate a first N/2 bit Nyquist filtered stream of symbols at an output;
d) a Q-channel comprising:
i. a second digital-to-analog converter having an input that is electrically connected to the second output of the splitter, the second digital-to-analog converter generating an analog signal representing the second N/2-bit stream of symbols at an output;
ii. a second Nyquist filter having an input that is coupled to the output of the second digital-to-analog converter, the second Nyquist filter generating a Q-channel Nyquist filtered N/2-bit stream of symbols; and
iii. a multiplier that multiplies the second Nyquist filtered N/2-bit stream of symbols by a sine function optical waveform to generate a first N/2 bit Nyquist filtered stream of symbols at an output; and
e) an optical combiner having a first optical input that is coupled to the I-channel and a second optical input that is coupled to the Q-channel, the optical combiner producing a combined optical beam with the first and second N/2-bit Nyquist filtered stream of symbols to generate a modulated optical beam, wherein the symbol rate is greater than N times a bandwidth of the modulated optical beam.

18. The optical data transmitter of claim 17 wherein the symbol generator comprises a memory containing look-up table data and a digital-to-analog converter, the digital-to-analog converter converting the look-up table data to the plurality of N-bit streams of symbols.

19. The optical data transmitter of claim 18 wherein the look-up table data comprises data selected to generate a plurality of N-bit streams of symbols that at least partially compensates for non-linear effects introduced during modulation.

20. The optical data transmitter of claim 17 wherein at least one of the first and the second Nyquist filter comprise a raised cosine filter that approximates a brick wall Nyquist filter.

21. The optical data transmitter of claim 17 wherein the optical modulator comprises a directly modulated laser.

22. The optical data transmitter of claim 17 wherein the optical modulator comprises an external optical modulator having an optical input that is coupled to an output of an optical source.

23. The optical data transmitter of claim 17 wherein the symbol rate approaches twice the bandwidth of the modulated optical beam.

24. A method of optically modulating a stream of symbols, the method comprising:
a) generating a stream of symbols having a symbol rate;
b) filtering the stream of symbols with a Nyquist filter; and
c) modulating an optical beam with the filtered stream of symbols thereby generating a modulated optical beam, wherein the symbol rate is greater than a modulation bandwidth of the modulated optical beam.

25. The method of claim 24 wherein the generating the stream of symbols comprises generating at least one of an impulse, a NRZ pulse, and a RZ pulse.

26. The method of claim 24 wherein the generating the stream of symbols comprises generating quadrature amplitude modulated pulses.

27. The method of claim 24 wherein the generating the stream of symbols comprises generating polarization multiplexed pulses.

28. The method of claim 24 wherein the symbol rate approaches twice the modulation bandwidth.

29. The method of claim 24 further comprising modifying at least some of the stream of symbols to at least partially compensate for non-linear effects introduced when modulating the optical beam.

30. The method of claim 24 wherein the modulating the optical beam comprises directly modulating the optical beam.

31. The method of claim 24 wherein the modulating the optical beam comprises externally modulating a CW optical beam.

32. The method of claim 24 wherein the modulating an optical beam comprises externally modulating a pulsed optical beam.

33. The method of claim 24 wherein the symbol rate approaches twice the modulation bandwidth.
